(19) United States
(12) Patent Application Publication
(10) Pub. No.: US 2012/0047026 A1
(43) Pub. Date: Feb. 23, 2012

(54) System and Method for Recruiting, Analyzing and Promoting Creative Submission

(75) Inventors: Matthew J. Ranauro, Erie, CO (US); John T. Winsor, Boulder, CO (US); Sean M. Zehnder, Longmont, CO (US); Claudia I. Batten, Boulder, CO (US); Evan H. Fry, Boulder, CO (US); Noah D. Clark, Boulder, CO (US)

(73) Assignee: VICTORS & SPOILS, INC., Boulder, CO (US)

(21) Appl. No.: 13/206,661

(22) Filed: Aug. 10, 2011

Related U.S. Application Data
(60) Provisional application No. 61/372,180, filed on Aug. 10, 2010.

(51) Int. Cl. G06Q 30/02

(52) U.S. Cl. 705/14.72

(57) ABSTRACT

A cross-service development and distribution system for presenting a creative brief to a user comprises at least one instance of a server based fan machine, the fan machine comprising a database structure and an interface between the database structure and a social network platform, at least one instance of a server based agency machine, the agency machine comprising a database structure and an interface between the agency machine database structure and the fan machine database structure, and a partner dashboard, the partner dashboard comprising a database structure and an interface between the partner dashboard database structure and the fan machine database structure and an interface between the partner dashboard database structure and the agency machine database structure. Accordance with some aspects the interface between the partner dashboard database structure and the fan machine database structure is initiated through the fan machine by an authorization command from the agency machine.

### PRIORITY AND RELATED APPLICATIONS

This application claims the benefit of Provisional U.S. Patent Application No. 61/372,180 filed on Aug. 10, 2010. The details of application No. 61/372,180 are incorporated by reference into the present application in its entirety.

### FIELD OF THE INVENTION

Aspects of the present invention relate to the use of crowd-sourcing techniques to distribute, recruit, analyze and promote creative concepts and submissions. More specifically, aspects of the present invention relate to the use of one or more social networking platforms, or other client interface portals, to distribute, refine, channel and select a creative submission while maintaining the ability to coordinate through an administrative or other professional review consultant.

### BACKGROUND

Creative departments, advertising agencies, and other groups have long utilized in-house employees and other traditional employment arrangements to develop and prepare branding strategies, advertisement copy, and other creative works (“Projects”) for a particular client. Competition for jobs at such firms is high, and it is often difficult for a part-time or otherwise burgeoning artist to get his works noticed or even considered for any type of large scale campaign. To date there has not been an effective system in place for soliciting from a large audience (“the crowd”) proposals for creative works such as those described above.

In addition, brand-centric companies have not in the past been able to collaborate with a professional services firm while also taking advantage of the high volume traffic and other fan-enabled services created by the world of social networking that provide an enabling function to integrate crowd participation, agency review and partner interaction with the selection and solicitation of creative concepts and other elements.

### SUMMARY OF THE INVENTION

In one embodiment, various aspects of a particular project are displayed for the public at large to review and submit a proposed concept through an electronic interface such as a web portal or other on-line system.

In one embodiment, aspects of a proposed Project or proposal are displayed for the artists (users) in a creative brief that includes, for example, details concerning the proposed brand context, the overall objective for the branding effort, the cultural context of the project, a strategy about the brand, and various metrics that may be utilized to evaluate the submissions.

In accordance with one embodiment, a cross-service development and distribution system for presenting a creative brief to a user comprises at least one instance of a server based fan machine, the fan machine comprising a database structure and an interface between the database structure and a social network platform, at least one instance of a server based agency machine, the agency machine comprising a database structure and an interface between the agency machine database structure and the fan machine database structure, and a partner dashboard, the partner dashboard comprising a database structure and an interface between the partner dashboard database structure and the fan machine database structure and an interface between the partner dashboard database structure and the agency machine database structure. Accordance with some aspects the interface between the partner dashboard database structure and the fan machine database structure is initiated through the fan machine by an authorization command sent from the agency machine.

In accordance with another aspect, a method for creative development and distribution comprises creating a brief that defines a project, enabling access to the project on a social network platform through a fan machine platform, soliciting a plurality of ideas and concepts from a community of users through the fan machine platform, screening the plurality ideas and concepts through an agency platform and filtering out unwanted material from the plurality of submitted ideas, providing an interface for community voting on at least one of the submitted ideas, enabling a third party to edit and comment on at least one of the submitted ideas, and selecting one or more of the submitted ideas. Other embodiments and aspects will become apparent after reading the detailed description provided herein.

### BRIEF DESCRIPTION OF THE DRAWINGS

Various objects and advantages and a more complete understanding of the present invention are apparent and more readily appreciated by reference to the following detailed description and to the appended claims when taken in conjunction with the accompanying drawings wherein:

FIG. 1 is an architectural diagram showing a cross-service integration of the various systems used in connection with aspects of the present invention;

FIG. 2 is a flow chart showing one embodiment of a cross-service development and distribution system in accordance with aspects of the present invention;

FIG. 3 is a detailed architectural diagram showing a cross-service integration of the various systems used in connection with aspects of the present invention;

FIG. 4 is a machine implemented component architecture that may be used in connection with aspects of the present invention; and

FIGS. 5 and 6 are embodiments of application program interfaces that may be utilized in connection with aspects of a system constructed in accordance with the present invention.

### DETAILED DESCRIPTION

Aspects of this invention relate to systems and methods that enable a company to solicit, supervise, evaluate, award, and promote creative submissions from a large number of independent or otherwise unrepresented artists and authors. Aspects of the invention also relate to the use of a distributed network to administer, control, review and select a creative concept from a large group of individuals while maintaining the ability to selectively engage a professional pool of consultants to help evaluate and fine tune the creative submissions.

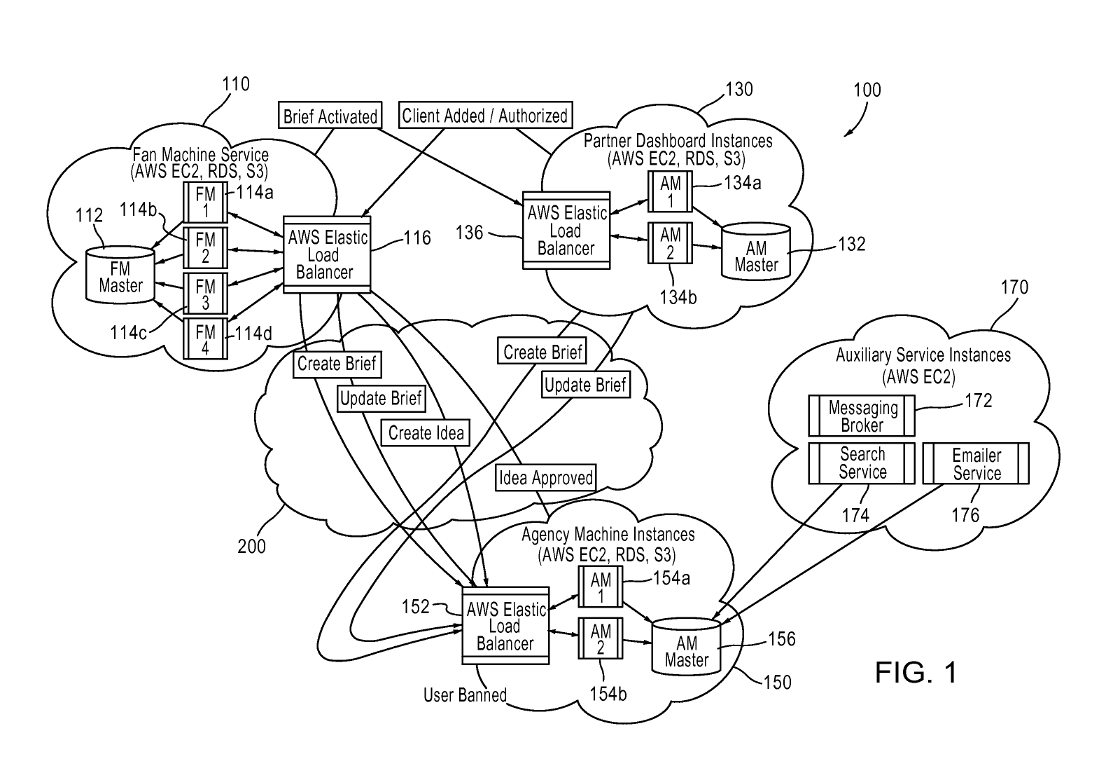

With reference to FIG. 1, a cross-service development and distribution system architecture 100 is shown. In an embodiment, various services are integrated into the overall system architecture 100 generally including a “fan machine” service 110, a “partner dashboard” 130, an “agency machine” 150 and in some embodiments an “auxiliary service” 170. In one embodiment each of the fan machine service 110, partner dashboard 130, agency machine 150 and auxiliary service 170 are hosted or otherwise managed on remote servers or other web application services such as for example, an Amazon Web Service. Alternatively, these components may be locally hosted by an individual company or client. Each are interconnected as described herein through a network connection, wide area network or web-based cloud computing interface. As described below, each of the fan machine service 110, the partner dashboard 130 the agency machine 150 and the auxiliary service 170 comprise various computer hardware components such as server systems, database structures, input and output devices and other peripheral hardware that enable the system machine to operate as an interconnected network of facilities. Cloud or network 200 is shown as one example of the system 100 being implemented across a distributed network such as the internet. It should be understood that each of the individual components in the system 100 may be located at various places throughout the network 200.

Fan machine service 110 is in one embodiment a user interface that provides a program interface that allows an individual the ability to receive, view and respond to various requests for creative submissions initiated by a company or other client. The fan machine 110 includes in one embodiment a fan machine master database 112, one or more fan machines 114a-114d and a network load balancer 116. One or more databases may be implemented in various embodiments. Fan machines 114a-114d are representative of any number of available fan machines distributed throughout the system and it should be understood that when the term “fan machine” is used herein applicant is inherently referring to one or more of such elements. The same applies to the agency machine and partner dashboard elements described herein.

A fan machine is in one embodiment an instance of a local service or other computer program running locally or in connection with a social networking platform. In one preferred embodiment, a fan machine is a program interface running on a customer promotional web page, such as a Facebook fan page, although any known or similar functioning social network platform is contemplated to function with aspect of the inventions described herein.

In one embodiment, each instance of the fan machine 114a-114d is unique to a particular client or user and comprises a simple interface that allows a user to transmit an idea (e.g. videos, images, written information, etc.) to a place where the idea can undergo more substantive review. Through one or more the fan machines 114a-114d users can submit their ideas through an existing community of users such as Facebook, Twitter, LinkedIn, YouTube, Instagram, etc. Broadly speaking, each instance of a fan machine provides a mechanism for any user in a particular community to submit thoughts, ideas or other creative information to be considered or evaluated by an organization or other professional association. In one embodiment (described further below) submissions taken through one or more of the fan machines are sent to an Agency Machine for further review, filtering and evaluation.

Each instance of a fan machine can be implemented as a platform specific application, e.g. a robust Facebook specific application that is linked into the Facebook page by a particular client, user or outside advertising agency. Instances of fan machines can also be implemented into other social networking platforms such as twitter or LinkedIn, although they might not be as robust as one implemented through a platform such as Facebook. Other embodiments include the Instagram or YouTube social platform for video or picture submissions.

Partner Dashboard 130 comprises dashboard master database 132, one or more instances of an ad machine 134a and 134b and a network load balancer 136. The partner dashboard 130 is in a preferred embodiment a client hub of data and also provides analytics to look at such metrics as the number of fans working on assignments, who are the top fans contributing ideas, forecasting with regard to specific campaigns underway, etc. The partner dashboard 130 sits in the network 200 between agency machine service 150 and fan machine service 110. In another embodiment, the partner dashboard provides an operational interface for users of the agency machine service 150 to link into a particular client's operations in order to provide in-depth review and analysis of advertising and marketing operations and campaigns, or otherwise provide real-time feedback into similar business efforts. In other embodiments, the partner dashboard provides analytical tools for a client or brand owner to view its brand performance across a spectrum of social network facilities. With ad machines deployed on a variety of social media platforms, the partner dashboard allows a client to view and monitor performance across all of the fan machine instances.

With continuing reference to FIG. 1, agency machine service 150 is provided as an intermediary communication module between fan machine service 110 and partner dashboard 130. The agency machine service 150 includes one or more agency machines 154a and 154b, an agency machine database 156 and a network load balancer 152. The agency machine service 150 provides the crux of communication capabilities with the one or more fan machines 114a-114d that are active in the network. The agency machines service 150 provides a professional level interface for the moderation and review to the potential mass of information submitted through the one or more fan machines. Because the cross-service development and distribution system 100 allows the submission of ideas and data through existing social networks, the potential for unwanted or inappropriate information being submitted is very high. Agency machine service 150 provides the ability to filter for unwanted or inappropriate information such as profanity, pornography, or otherwise inappropriate or unwanted information. Agency machine service 150 also provides a sophisticated interface for professional level substantive review of the submission provided through the one or more fan machines 114a-114d. Agency machine service 150 allows any “junk” submissions to be culled out before getting passed to the primary client for review. Automatic filters or flags may be implemented within the operational system of agency machine system 150 to only allow the important submissions to make it to later rounds of review and processing. Flags may be assigned within agency machine service 150 to identify high quality submissions and those flags or other markers may be passed along with the creative submission back to the client or back to the ad machines that originally posted the project (“brief”) for solicitation of ideas. If initiated through a social network such as Facebook, those or flags may be associated with the particular user of the social network so that others within the network may see the performance and/or success level of the creative user.

In other embodiments an auxiliary service 170 may be included in order to provide peripheral services to the cross-service development and distribution system 100 and more particularly to the users of the agency machine service 150. Auxiliary service 170 may include such features and systems as a messaging broker 172, a search service 174 and/or an email service 176. Messaging broker may be a text based SMS system or other short form messaging system for alerting users of the system to one or more milestones, events or other aspect of the system process. Search service 174 may be any know web-enabled search mechanisms for retrieving or research information. Emailer service 176 is any known email system client such as Gmail, Outlook, or their equivalent.

### Implementation and Process Example

In accordance with one embodiment, the preparation of a creative request (sometimes referred to as a “brief”), the solicitation of submissions and the eventual selection of a “winning” brief happen as follows in the context of the cross-service development and distribution system 100.

In one embodiment and example, a branded company (e.g. Harley Davidson, Coca Cola, Nike, etc.) initiates an advertising or marketing campaign. Such a campaign may be comprised of something as simple as the format of a new logo or slogan or may be as complex as the development of a new line of products or services. In either case, the company prepares a set of specifications or another written request that defines the specific parameters of the project. This request is referred to herein as a “brief.” In one scenario, the company already has a product or company fan page existing on a social networking site such as Facebook and preferably already has a number of existing fans of the company associated with that social networking platform. Fans of a particular company will automatically receive notices or other offers generated by the company and will be notified when the company posts its advertising or marketing brief on the Facebook page. Alternatively, someone who is not yet a fan of the company may receive the company's brief posting via a recommendation from one of their friends or the brief posting is forwarded to them from a system outside of Facebook.

In one embodiment, the company indicates, via its fan page, that the company is soliciting ideas for a new logo or other advertising collateral that the company wants to develop. The fan page indication includes a link that will take a particular fan to the company fan page and into a specific application (e.g. one of the fan machines 114a-114d) where a more complete description of the brief resides. This description may include instructions for the layout, style or formatting requirements, templates for the fan to use, etc. The fan can then work offline to create a idea in line with the requirements set forth in the brief and then upload the completed submission back into the fan machine service 110 through a fan machine application (in this case, resident on Facebook).

After submission, the uploaded submission gets sent through an API to the agency machine service 150 which provides a professional community of users the ability to review or otherwise analyze the submission. One or more users in the agency machine professional community may then review the submissions and can provide an initial rank and/or review indications through the agency machine service. These may be accomplished via simple radio buttons incorporated into the agency machine service or any other mechanism for flagging or otherwise segregating the submissions. The user on the agency machine service 150 may also have the ability to assign additional moderation feedback for this first level review (e.g. yes, no, profanity, block, high level, high pick, etc.). After the first level review the submission may be distributed back to the fan machine service 110 with the appropriate notation or status flag.

The fan machine service 110 in one embodiment may provide aspects relating to a particular brief or user to a leader board or other ranking mechanism. In this sense the more effective or talented users may be publically identified. The leader board is in one embodiment presented on the specific company fan page within Facebook but may also be presented in a more broad facing environment. The leader board may be specific for a given brief or project or may be formatted for a user's overall performance throughout the history of the fan's online career.

In another embodiment, the fan machine service 110 may also include a voting system in connection with the brands and that gets presented to the company's fan base at large. The selection of submissions that get presented to the overall fan base may be randomly generated or selected by the company or brand owner. Fans may be presented with the opportunity to either vote yes/no, positive/negative, etc. Due to the inherent Facebook functionality, an individual fan has ability to share a submission or brief with other fans or personal friends.

At some point after the submission process through the one or more fan machines 114a-114d, the company or brand owner is in a position to select one or more of the submitted ideas as the “winner.” This may take place while considering the rankings posted on the social network fan page after voting by fans or may be made independently by the company. In one embodiment, the leaderboard is just a suggestion to the company (e.g. “here is what your fans think”), and the final selection is still a manual process executed by the company, with possible contribution by a resource generated through the agency machine platform. In line with the brief posted by the company, the company can associate a prize with each brief which can range from a novelty item to a substantial cash payment.

Through the partner dashboard 170 a client can install a particular fan machine application for use in its marketing and advertising campaign. In one embodiment, an authorization to use the fan machine service 110 needs to be initiated in order to allow the company or client to enable the system. License keys, tokens or other authorization schemes may be granted to the company by the owner of the cross-service development and distribution 100 to initiate the fan machine for use.

In one embodiment, the fan machine service 110 is server based and resides at a server location remote from the social network such as on an Amazon Web Service platform. Once a client is authorized to use a particular embodiment of a fan machine they will be authorized to access an administrative dashboard on the partner dashboard 130 in order to run the fan machine system 110. The partner dashboard 130 provides the ability to do one or more of creating briefs, distributing briefs, reviewing submissions, etc.

One or more forms of direct marketing efforts may be utilized to direct the brief via partner dashboard to a specific demographic of users or fans. For example, a project that involves the creation of a new motorcycle for women between the ages of 19-25 can be directed to the appropriate demographic of fans and only a specifically selected set of fans will be enabled to view the brief on Facebook.

As mentioned above, brief creation and management is accomplished within the partner dashboard 130 and the partner dashboard 130 includes administrative functions for brief creation and administration. In addition, the Agency machine 150 may provide an outside agency or consultant an access panel into the client dashboard so that additional marketing consultation may occur in connection with the company's brand management or overall marketing strategy. In this sense, the agency machine provides a platform for providing information to the company as to what gaps may exist in a marketing campaign or strategy and allows the outside consultant to assist in normalizing any spikes and dips within a brand campaign. Data is pulled in from the partner dashboard and then the user of the agency platform can provide consulting information as to where the company should be directing their marketing. In other embodiments, the partner dashboard provides a reporting interface into all of the social media platforms utilized by the company to determine who is contributing and which platforms are being the most effective. In this sense, the partner dashboard may provide information feeds from each of the fan machines utilized by a client for a particular brand campaign or other project. The partner dashboard may also include operational instances of report publishing with refined analytics and reports based on this data including preformed templates or other reporting tools.

As used above, the overall cross-service development and distribution system 100 may include one or more physical devices and networked hardware to effect the operation of the system or application. For instance, each of the database structures 112, 132 and 156 may be standalone units or may comprise a common database that is shared amongst several clients. Depending on the size and complexity, one or more clients may receive a dedicated database. Each of the fan machine's 114a-114d are preferably implemented as individual web applications or servers. As with the database structures, these may also be shared or dedicated environments. The load balancers 116, 136 and 152 are routing mechanisms to split up load appropriately and to send data to the proper server.

While the agency machine service 150 has a generally similar system architecture to the fan machine service 110, the agency machine service 150 also includes an API that allows connections into the user accounts and workflow tools for monitoring and maintenance/distribution of tasks (e.g. look at a particular submission).

With further reference to FIG. 1, the various data paths and interconnections show how information is moved and processed within the overall cross-service development and distribution system 100 and how the different components are interconnected with each other. For instance, the fan machine service 110 and the agency machine service 150 allow functions such as creating and updating a brief, creating an idea and approving an idea to be shared between the two services.

In accordance with one particular embodiment, when a fan creates a submission through a fan machine, it is transmitted to the agency machine system 150 in real time for someone to substantively review. After review, the submission can get pushed back to the fan machine resident on a Facebook page and posted to a leader board. Through the partner dashboard the client has a view of every idea submitted. It is then up to the client which one of the submissions to select. The winning author or artist gets contacted and is awarded for his success.

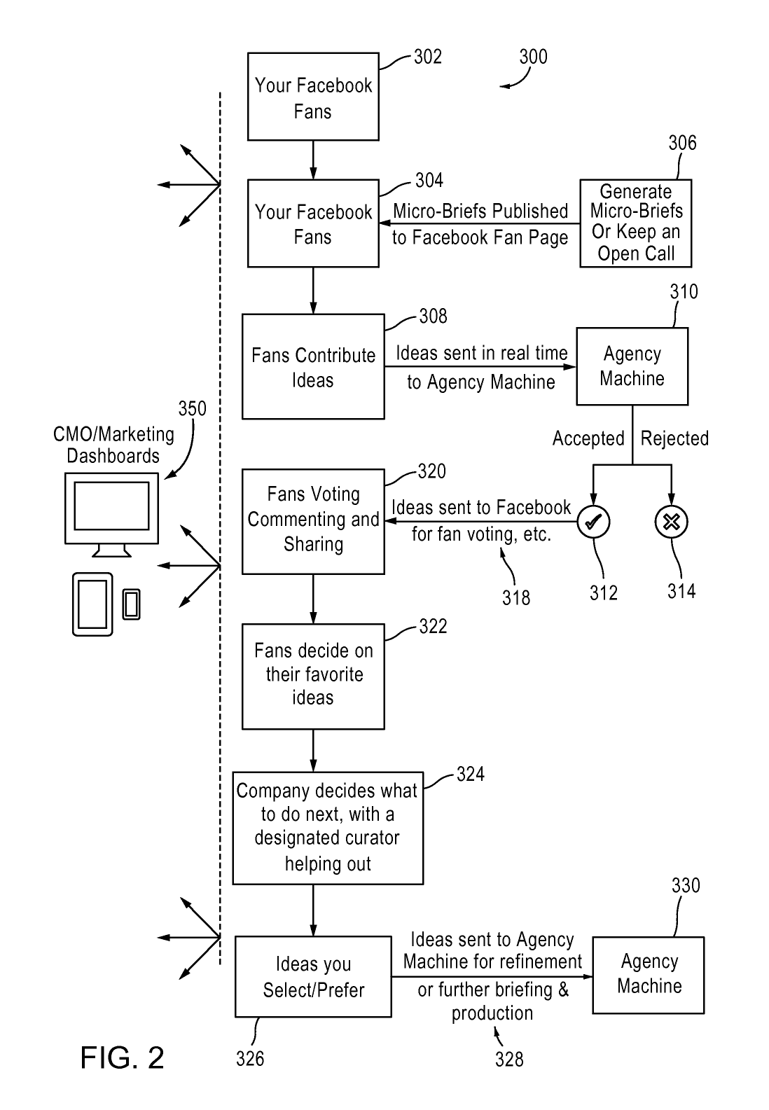

Referring now to FIG. 2, a process flow is shown that represents one embodiment of a method 300 of implementing a cross-service development and distribution system 100. In one embodiment, a group of Facebook or other social networking fans 302 is distributed or presented with a brief or other specification 304 about a particular project that a client or company desires to implement and solicit ideas for. Briefs are generated directed on the fan machine platform or can also be generated in an off line environment 306 where they are subsequently published to the fan machine resident on the Facebook platform. At 308 fans review the brief and submit ideas in response thereto. As ideas are submitted, they are published and transmitted in real time to an agency machine at 310 where they are either accepted at 312 or rejected at 314. Rejected submissions are archived at 316. Accepted submissions are sent to the fan machine resident on a Facebook platform for potential voting at 318 with commenting and sharing also available at 320. Fan feedback as to the top choices is accomplished at 322 and this information is shared with the company at 324 where the company makes the ultimate decision as to which submission is the best. In one embodiment, one or more of the top ideas 326 and ideas are sent back 328 to the agency machine at 330 where an outside consultant can contribute, refine or otherwise modify the end-result submissions for final presentation to the company.

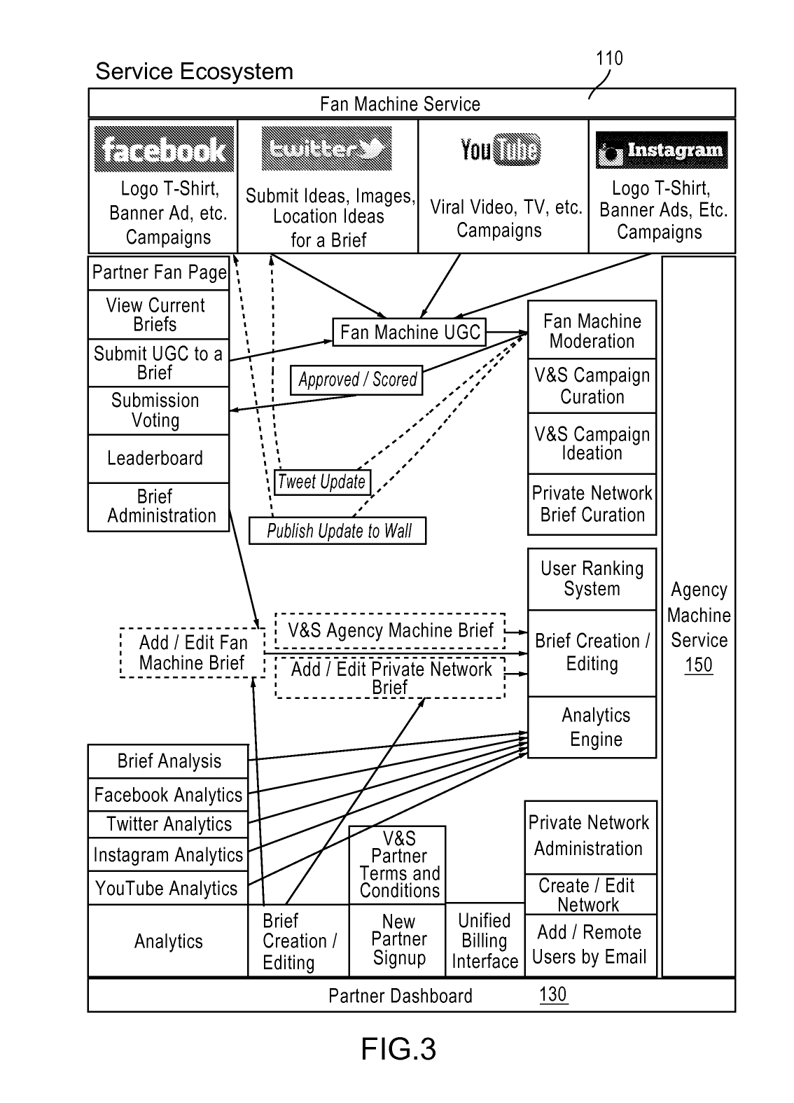

With reference to FIG. 3, a higher resolution image of third party integration into the fan machine architecture is shown. As with FIG. 1, FIG. 3 shows representations of the fan machine service 110, partner dashboard 130 and agency machine service 150. Fan machine service 110 in one embodiment sits or resides as an application on a social network or other communication platform such as Facebook, Twitter, YouTube or Instagram. Depending on the particular desire of a client or company, the choice of social platform will vary. For example, a logo, t-shirt, banner ad campaign, etc. would be more conducive to a Facebook platform, while the submission of a generalized idea or image might be better suited for a campaign built upon a twitter platform. Similarly, a viral video or television campaign would be suited for a YouTube platform to host the ad machine while Instagram might be better suited for images and photograph submissions. Aspects of the present invention allow the instances of the fan machine, agency machine and partner dashboard are layered over the particular business model of the client and allows solicitation, review, modification and promotion of a brand campaign under a single integrated system.

The fan machine service 110 supports various functions such as a partner fan page, the ability to view current briefs or specifications, the ability to submit user-generated content to a brief, provisions for voting on a particular brief or user, production and display of a leader board, and overall brief administration.

Agency machine service 150 supports various functions such as fan machine moderation, outside campaign curation and ideation, private network brief curation, a user ranking system, the ability to provide brief creation and editing, and an analytics engine.

Partner dashboard 130 support various functions such as an analytics engine, which itself may comprise analytics for one or more social media platforms and the ability to analyze a brief itself. The partner dashboard may also provide brief creation and editing capabilities, administrative functions such as new partner signup features and software license administration, a billing interface and various other administration features such as private network administration, creation and editing of networks and user account maintenance.

Interrelation of the various platforms and functions are shown in FIG. 3 via arrows. For instance, the partner dashboard analytics engine is tied to the analytics engine built into the agency machine and the brief creation and edits capabilities are linked across the fan machine platform 110, the agency machine 150 and the partner dashboard 130.

### Rank Engine

Aspects of the invention also include a rank engine that comprises a data collection and analysis framework. This engine powers insights about users, projects, and clients in the agency machine. The rank engine is an extremely flexible toolkit that allows us to easily glean insights from system metrics and admin-generated tags in order to understand, for example, who the most valuable community members are (General Rank), as well as more specific queries such as “who are the best people for ‘edgy tv writing’.”

In accordance with one embodiment, the rank engine has two basic metric types: system metrics and admin-assigned tags. Both system metrics and tags are in one form key/value pairs, which can be used for rank or other queries. Each of these key/value pairs will be referred to as a ‘metric.’ System metrics may include information such as:
Avg. number of ideas contributed per project
Total number of ideas submitted
Percent of public briefs read
Percent of public briefs accepted
Number of ideas designated as ‘Yes’
Number of ideas designated as ‘No’

Admin-assigned metrics provide additional meta-data that is useful to characterizing and ranking users, such as:
“Good Writing”+2
“Good Attitude”+3
“Quality Comps”+1
“Edgy”+7

In order to statistically summarize the community of users, an administrator creates a Rank Schema. The Rank Schema is essentially a list of metric names along with a weight (or multiplier). Schema are designed for a specific purpose. So, for example, if you only wanted to the best folks for “edgy tv writing,” you would only include the metrics that are useful for describing just that.

To generate a Rank Score, the schema is run against each user's scorecard—where each schema entry is multiplied by the corresponding user metric—and then the weighted numbers are summed to produce an overall score for each user for that schema. The scores for a schema are then organized into a histogram in order to understand the relative rank of each user for that given schema. General Rank is preferably one of these schema that includes many of the system and admin-assigned metrics.

Aspects of the cross-service development and distribution system may also include the following functions and capabilities:
1. Areas for users to upload images and other graphic representations of their work;
2. Account creation modules for tracking and maintaining artistic submissions as well as user account information and personal data, including email and contact information, login credentials, professional credentials and resume information, specialties and preferences for additional work;
3. A communications module for communicating with and being monitored and managed by the system moderator, manager or director and for posting and receiving messages;
4. Capabilities that allow for easy matching of users to customers based on user's level of experience and types of expertise, ranking of each user relative to their peers, ability to form a team of multiple users and associated team-based collaboration tools.

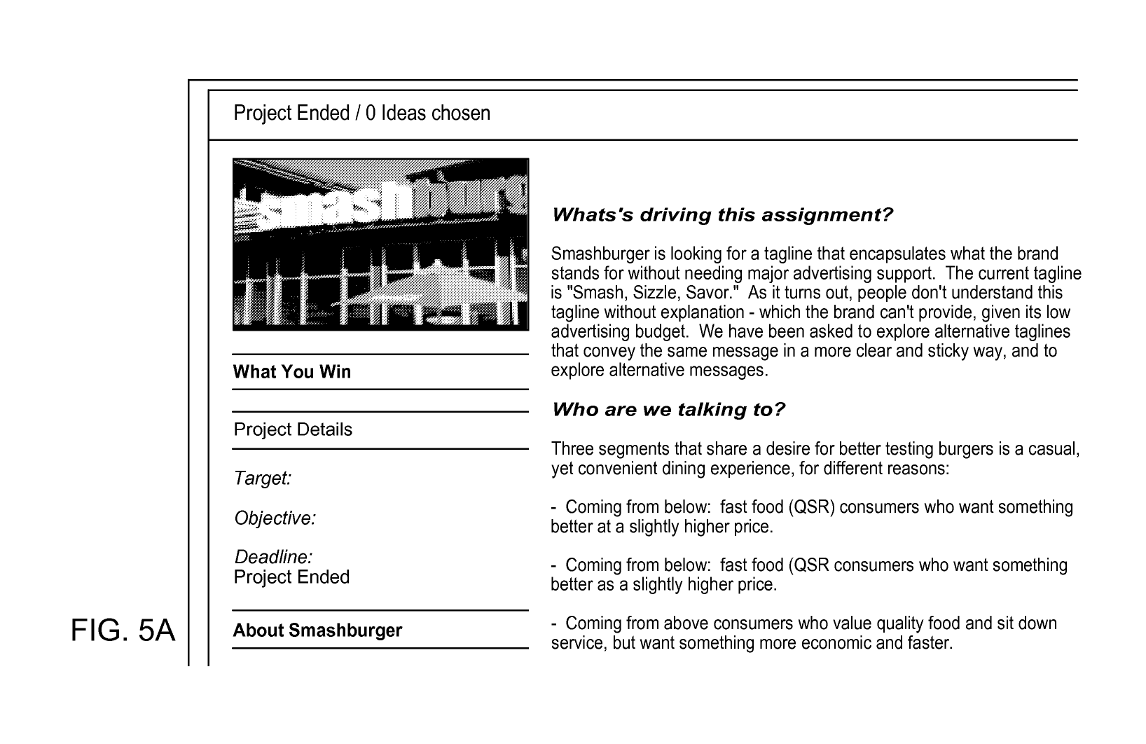

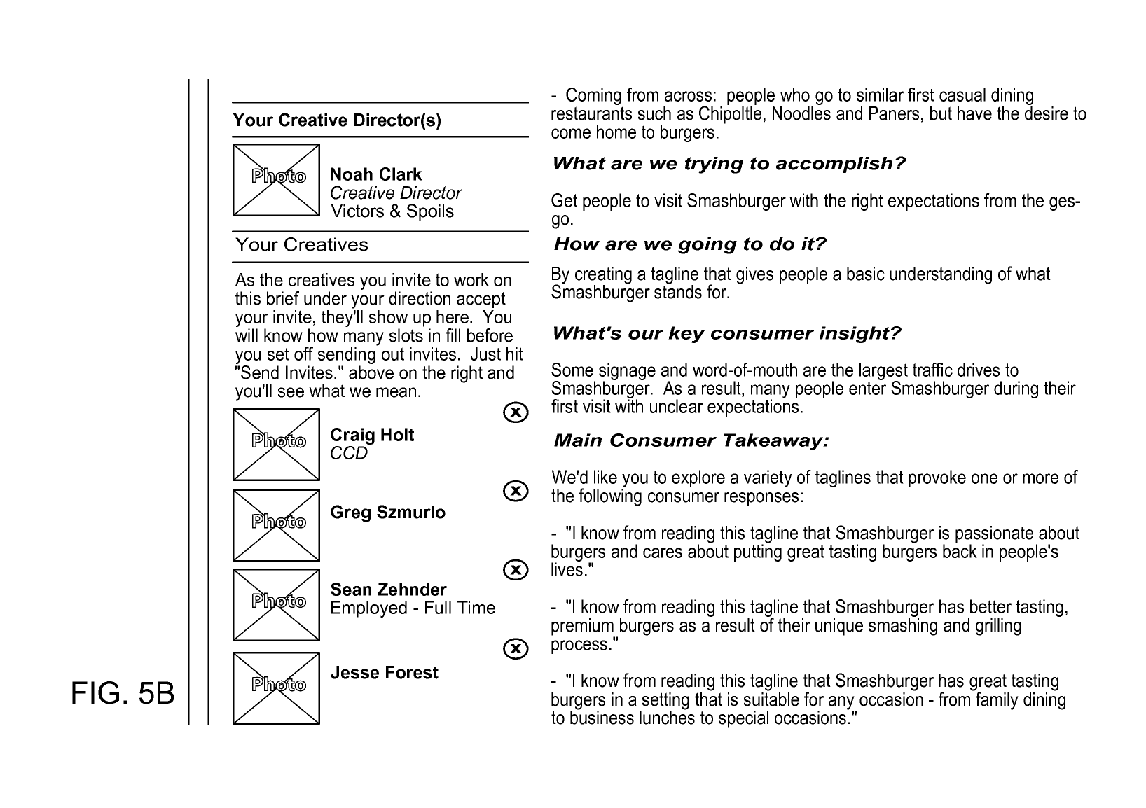

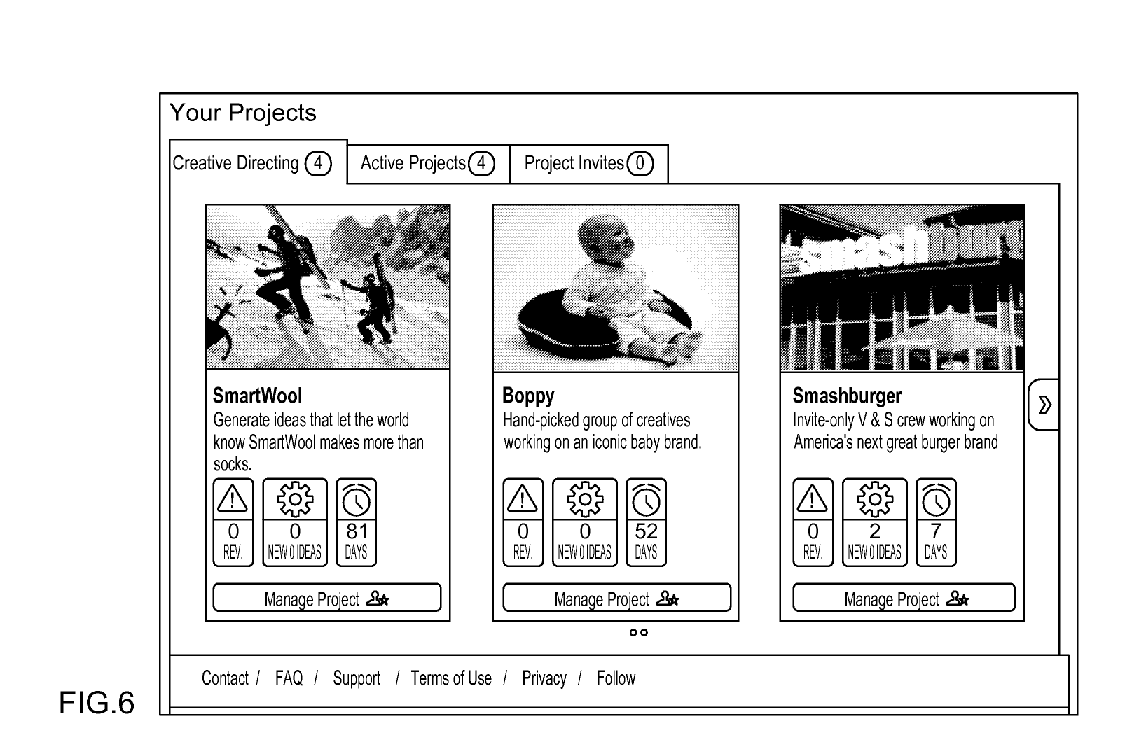

FIGS. 5 and 6 show various application program interfaces that may be used in connection with aspects of the present invention such as a brief page interface (FIG. 5) and a partner dashboard page interface (FIG. 6).

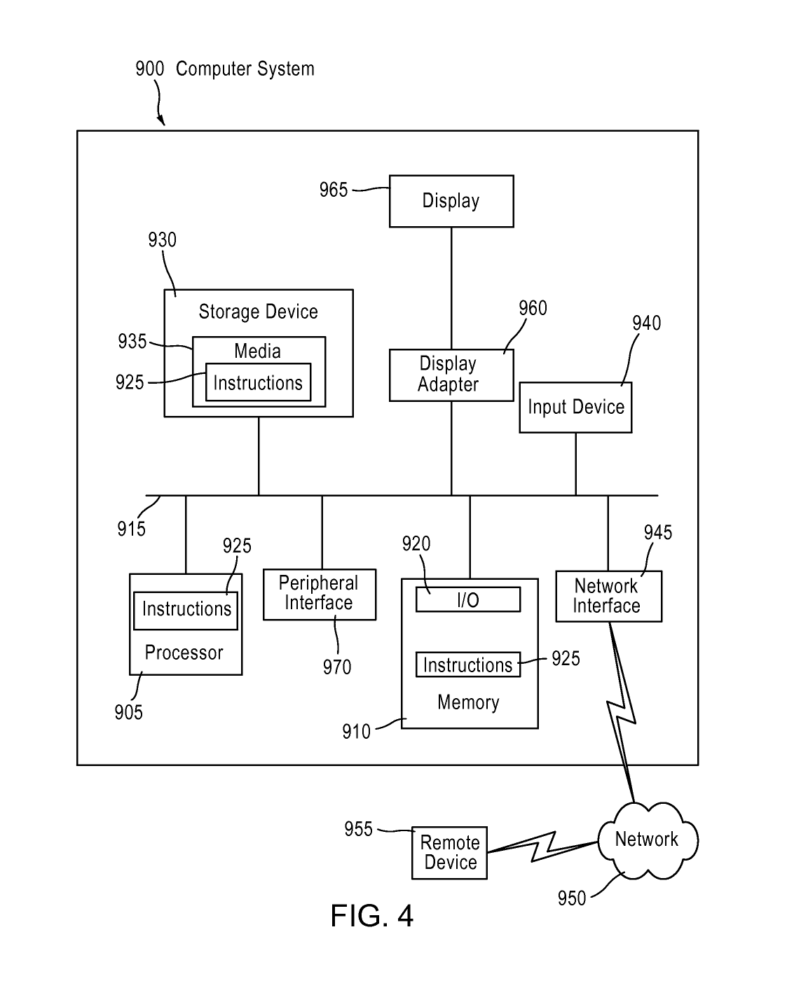

In addition, FIG. 4 shows a diagrammatic representation of one embodiment of a machine in the exemplary form of a computer system 900 within which a set of instructions for causing a device to perform any one or more of the aspects and/or methodologies of the present disclosure to be executed. Either of the fan machine system 110, the agency machine system 150, the partner dashboard 130 or the auxiliary service 170 may be implemented in accordance with the hardware and machine descriptions set forth herein.

Computer system 900 includes a processor 905 and a memory 910 that communicate with each other, and with other components, via a bus 915. Bus 915 may include any of several types of bus structures including, but not limited to, a memory bus, a memory controller, a peripheral bus, a local bus, and any combinations thereof, using any of a variety of bus architectures.

Memory 910 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 920 (BIOS), including basic routines that help to transfer information between elements within computer system 900, such as during start-up, may be stored in memory 910. Memory 910 may also include (e.g., stored on one or more machine-readable media) instructions (e.g., software) 925 embodying any one or more of the aspects and/or methodologies of the present disclosure. In another example, memory 910 may further include any number of program modules including, but not limited to, an operating system, one or more application programs, other program modules, program data, and any combinations thereof.

Computer system 900 may also include a storage device 930. Examples of a storage device (e.g., storage device 930) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 930 may be connected to bus 915 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 930 may be removably interfaced with computer system 900 (e.g., via an external port connector (not shown)). Particularly, storage device 930 and an associated machine-readable medium 935 may provide nonvolatile and/or volatile storage of machine-readable instructions, data structures, program modules, and/or other data for computer system 900. In one example, software 925 may reside, completely or partially, within machine-readable medium 935. In another example, software 925 may reside, completely or partially, within processor 905. Computer system 900 may also include an input device 940. In one example, a user of computer system 900 may enter commands and/or other information into computer system 900 via input device 940. Examples of an input device 940 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 940 may be interfaced to bus 915 via any of a variety of interfaces (not shown) including, but not limited to, a serial interface, a parallel interface, a game port, a USB interface, a FIREWIRE interface, a direct interface to bus 915, and any combinations thereof.

A user may also input commands and/or other information to computer system 900 via storage device 930 (e.g., a removable disk drive, a flash drive, etc.) and/or a network interface device 945. A network interface device, such as network interface device 945 may be utilized for connecting computer system 900 to one or more of a variety of networks, such as network 950, and one or more remote devices 955 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 950, may employ a wired and/or a wireless mode of communication. In general, any network topology may be used. Information (e.g., data, software 925, etc.) may be communicated to and/or from computer system 900 via network interface device 945.

Computer system 900 may further include a video display adapter 960 for communicating a displayable image to a display device, such as display device 965. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 900 may include one or more other peripheral output devices including, but not limited to, an audio speaker, a printer, and any combinations thereof. Such peripheral output devices may be connected to bus 915 via a peripheral interface 970. Examples of a peripheral interface include, but are not limited to, a serial port, a USB connection, a FIREWIRE connection, a parallel connection, and any combinations thereof. In one example an audio device may provide audio related to data of computer system 900 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 965. Accordingly, a digitizer may be integrated with display device 965, or may exist as a separate device overlaying or otherwise appended to display device 965.

Other aspects of a system and method constructed in accordance with the description provided herein will be known to those of skill in the art.

What is claimed is:

1. A cross-service development and distribution system for presenting a creative brief to a user, the system comprising:
at least one instance of a server based fan machine, the fan machine comprising a database structure and an interface between the database structure and a social network platform;
at least one instance of a server based agency machine, the agency machine comprising a database structure and an interface between the agency machine database structure and the fan machine database structure;
a partner dashboard, the partner dashboard comprising a database structure and an interface between the partner dashboard database structure and the fan machine database structure and an interface between the partner dashboard database structure and the agency machine database structure;
wherein the interface between the partner dashboard database structure and the fan machine database structure is initiated through the fan machine by an authorization command sent from the agency machine.

2. The cross-service development and distribution system of claim 1, wherein each of the server-based fan machines comprise a user interface for reviewing and responding to requests for creative submissions.

3. The cross-service development and distribution system of claim 1, wherein the server-based agency machine comprises a user interface for monitoring and maintaining the submissions generated and submitted through the one or more server-based fan machines.

4. The cross-service development and distribution system of claim 1, wherein the partner dashboard comprises a user interface for creating and initializing the brief for presentation to a user.

5. The cross-service development and distribution system of claim 4, wherein the brief is comprised of a specification that details elements of a creative submission.

6. The cross-service development and distribution system of claim 1 further comprising a network load balancer coupled to the server-based fan machine.

7. The cross-service development and distribution system of claim 1, wherein the agency machine comprises a control interface with both the server-based fan machines and the partner dashboard and wherein the control interface allows a user of the agency machine to filter, organize and approve submissions submitted through at least one of the server-based fan machines.

8. The cross-service development and distribution system of claim 1 further comprising an auxiliary service system coupled to the server-based agency machine and adapted to provide one or more of messaging services and search services.

9. The cross-service development and distribution system of claim 1 wherein the server-based fan machine and the agency machine are remotely deployed.

10. The cross-service development and distribution system of claim 1 wherein the server-based fan machine and the agency machine are locally deployed.

11. The cross-service development and distribution system of claim 1 wherein the fan machine is enabled through a social network interface.

12. The cross-service development and distribution system of claim 1 wherein the social network interface is selected from one of Facebook, Twitter, YouTube and Instagram.

13. The cross-service development and distribution system of claim 1 wherein the server-based fan machine provides for at least one of submission voting and a leaderboard.

14. The cross-service development and distribution system of claim 1 wherein the server-based fan machine provides an interface to a partner fan page.

15. The cross-service development and distribution system of claim 1, wherein the agency machine provides for at least one of fan machine moderation, client campaign curation, a user ranking system, brief creation, brief editing and an analytics engine.

16. A method for the development, refinement and distribution of creative submissions, comprising:
creating a brief that defines a project;
enabling access to the brief on a social network platform through a computer server based fan machine platform, the fan machine platform including electronic database structure for storing the brief;
soliciting a plurality of ideas and concepts from a plurality of social media communities through the fan machine platform;
screening the plurality ideas and concepts through an agency platform and filtering out unwanted material from the plurality of submitted ideas;
providing an interface for community voting on at least one of the submitted ideas;
enabling a third party to edit and comment on at least one of the submitted ideas; and
selecting one or more of the submitted ideas.

17. The method of claim 16, wherein the plurality of social media communities includes at least two of Facebook, Twitter, YouTube, and Instagram.

18. The method of claim 16, wherein the agency machine platform allows the third party to revise at least one of the submitted ideas and transmit that revised idea back to a user who created the brief.

19. The method of claim 16, wherein the server-based fan machine and the agency machine are locally deployed.

20. The method of claim 16, wherein the server-based fan machine and the agency machine are remotely deployed.
